(19) United States
(12) Patent Application Publication
(10) Pub. No.: US 2011/0222608 A1
(43) Pub. Date: Sep. 15, 2011

(54) LOCALIZED IN-LOOP FILTERING WITH MULTIPLE FILTERS IN HYBRID VIDEO CODING

(76) Inventors: Yongying Gao, Beijing (CN); Yu-Wen Huang, Taipei City (TW); Shaw-Min Lei, Taipei County (TW)

(21) Appl. No.: 12/997,879

(22) PCT Filed: Nov. 23, 2010
(86) PCT No.: PCT/CN10/79002

§ 371 Date: Dec. 14, 2010

Related U.S. Application Data
(60) Provisional application No. 61/313,840, filed on Mar. 15, 2010.

(51) Int. Cl. H04N 7/26

(52) U.S. Cl. 375/240.24; 375/E07.026

(57) ABSTRACT

A method for coding a parent block of video data includes: reconstructing the parent block for prediction; providing at least two filters for filtering the parent block after reconstructing the parent block; dividing the parent block into block partitions, wherein at each block partition determining which of the filters is to be used to filter the block partition; and filtering each of the block partitions with the filter determined accordingly.

### TECHNICAL FIELD

This invention relates to in-loop filtering methods, and more particularly, to in-loop filtering methods that employ hybrid video coding.

### BACKGROUND

Modern audio-visual systems utilize digital coding to reduce data size. Digital coding methods utilize both intra and inter prediction techniques to compress and decompress data for picture frames. These frames are coded, and reconstructed and may be utilized to predict data for a next frame. Reconstructed data forming a frame can often have blocking artifacts at the corners of macroblocks; therefore, most modern encoders and decoders utilize a deblocking filter in order to remove these blocking artifacts. A common technology is H.264. Unfortunately, while blocking artifacts at block boundaries can be removed, quantization errors will still remain.

Therefore, modern coding techniques employ Wiener filtering, which acts to generate filter coefficients according to Wiener-Hopf equations, such that a reconstructed frame can be generated that has reduced quantization errors. For a typical case, an input signal s will undergo some coding processes, introducing additive quantization noise e, which generates a noisy signal s′. The Wiener filter filters the noisy signal s′ to generate a filtered signal ŝ wherein the mean square error between s and s′ is minimized, such that the filtered signal ŝ will be closer to the original signal s.

Wiener filter information is also required at the decoder side to reconstruct the original video. For example, Wiener filter coefficients used by the encoder side are sent to the decoder side as the Wiener filter information. Even with this advanced filtering, however, there can be discrepancies within a particular frame. A single Wiener filter may not provide the optimized filtering for every macroblock within a frame.

### SUMMARY

Therefore, it is an objective of the present invention to provide adaptive loop filtering methods that are able to utilize a plurality of Wiener filters within a single frame.

A method for coding a parent block of video data comprises: reconstructing the parent block for prediction; providing at least two filters for filtering the parent block after reconstructing the parent block; dividing the parent block into block partitions, wherein at each block partition determining which of the filters is to be used to filter the block partition; and filtering each of the block partitions with the filter determined accordingly.

A method for coding a parent block of video data comprises: reconstructing the parent block for prediction; dividing the parent block into block partitions according to a partitioning method; determining one of a plurality of filtering methods for each of the block partitions; and filtering each of the block partitions with the corresponding filtering method; wherein the partitioning method is inferred from the parent block.

An encoder for encoding a parent block of video data comprises: a reconstruction block, for reconstructing the parent block for prediction; at least two filters for filtering the parent block after reconstructing the parent block; and a filtering information generation unit, for dividing the parent block into block partitions, wherein at each block partition the filtering information generation unit determines which of the filters is to be used to filter the block partition.

A decoder for decoding a parent block of video data comprises: a decoding entropy unit, for decoding a coded bitstream to retrieve the parent block of video data; a reconstruction block, for reconstructing the parent block for prediction; at least two filters for filtering the parent block after reconstructing the parent block; a filtering information generation unit, for dividing the parent block into block partitions, wherein at each block partition the filtering information generation unit determines which of the filters is to be used to filter the block partition.

### BRIEF DESCRIPTION OF DRAWINGS

FIG. 1 is a diagram of a frame divided according to quadtree block partitioning.

FIG. 2 is a diagram of an encoder according to an exemplary embodiment of the present invention.

FIG. 3 is a diagram of a decoder according to an exemplary embodiment of the present invention.

FIG. 4 is a quadtree diagram showing different filters according to a first embodiment of the present invention.

FIG. 5 is a quadtree diagram showing different filters according to a second embodiment of the present invention.

### DETAILED DESCRIPTION

The present invention aims to provide coding methods that can utilize different filters to code a single frame. Provided below are different embodiments for carrying out the objectives of the invention. In the following embodiments, Wiener filters are utilized to illustrate the methods and workings of the invention; please note, however, that any other filters that can perform the filtering methods detailed in the following also embody the spirit of the invention. Therefore, the Wiener filter should be taken as merely one example and not a limitation of the invention.

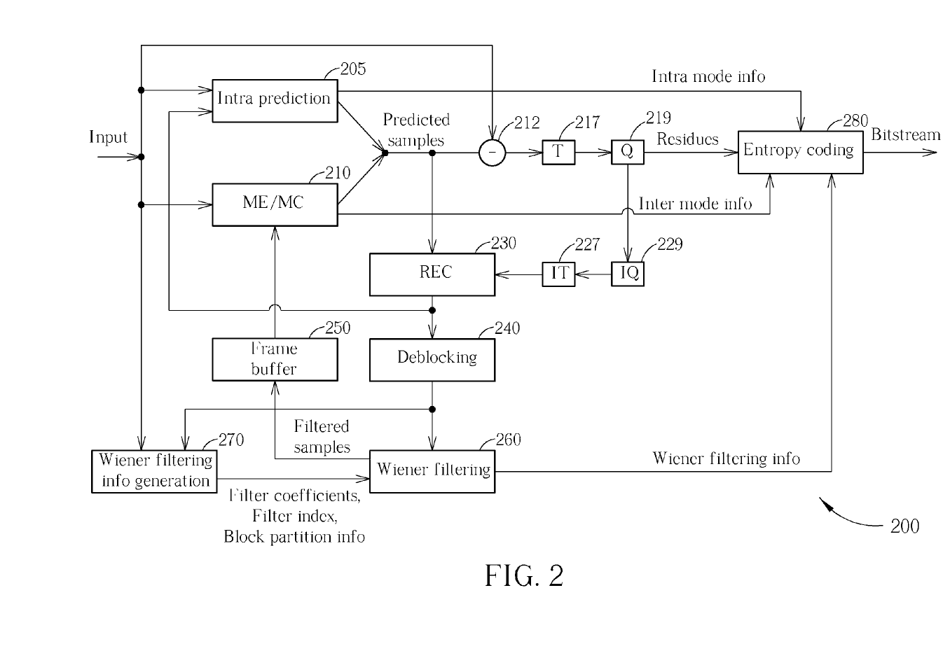

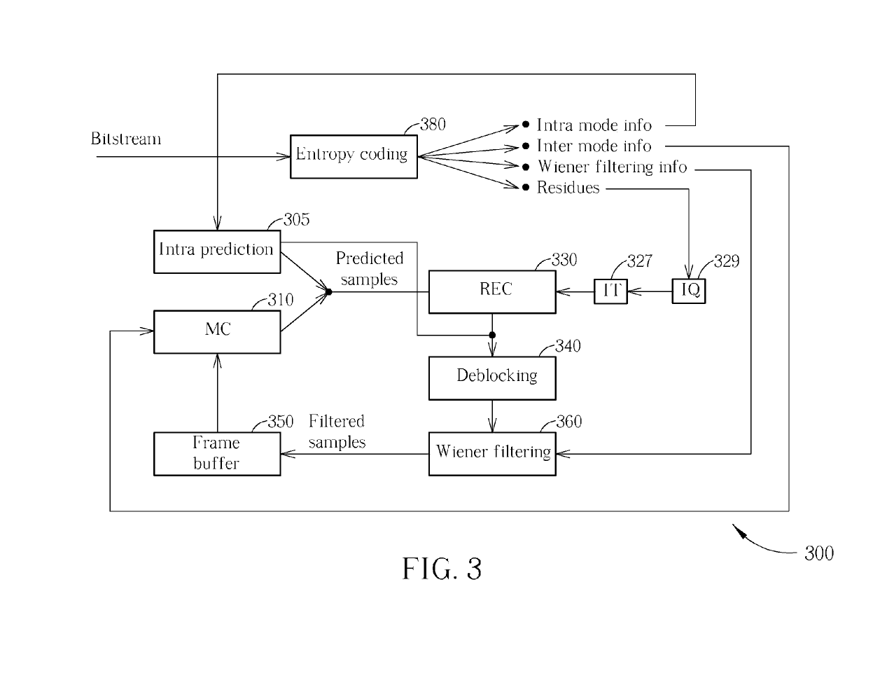

Please refer to FIGS. 2 and 3. FIG. 2 is a diagram of an encoder 200 for performing an encoding method according to an embodiment of the present invention, and FIG. 3 is a diagram of a decoder 300 for performing a decoding method according to an embodiment of the present invention. Briefly, the encoder 200 comprises an intra prediction unit 205, an inter prediction (Motion Estimation/Motion Compensation; ME/MC) unit 210, a subtractor 212, a transform unit 217, a quantization unit 219, an inverse transform unit 227, an inverse quantization unit 229, a reconstruction unit 230, a deblocking unit 240, a frame buffer 250, a Wiener filtering unit 260, a Wiener filtering information generation unit 270, and an entropy coding unit 280. Video data comprising a plurality of parent blocks (e.g. pictures) are fed to the intra prediction unit 205 and inter prediction unit 210 to generate predicted samples. Differences between the predicted samples and original video data are transformed and quantized into residues. The entropy coding unit 280 encodes prediction information such as intra mode information from the intra prediction unit 205 and inter mode information from the inter prediction unit 210, and the residues into a coded bitstream. The residues are inverse quantized and inverse transformed, and sent to the reconstruction unit 230 together with the predicted samples for reconstruction. The reconstructed parent blocks are sent to the deblocking unit 240 and Wiener filtering unit 260 to generate filtered samples for prediction. The Wiener filtering unit 260 can apply different Wiener filters to block partitions of a parent block, and the Wiener filtering information generation unit 270 generates Wiener filter coefficients corresponding to each Wiener filter to the Wiener filtering unit 260. The Wiener filtering information generation unit 270 may also send block partition information to the Wiener filtering unit 260. The Wiener filtering information generation unit 270 of some embodiments provides a filter index for each block partition to the Wiener filtering unit 260 for selecting one filter from a plurality of Wiener filters. The filter index in another embodiment indicates whether the corresponding block partition has been filtered at the encoder side, and if so, which filter has been employed. Depending on which Wiener filter is employed for each block partition, Wiener filtering information will be generated and sent to the entropy coding unit 280 for notifying corresponding decoders. The Wiener filtering information may comprise a filter index for each block partition, flags or statistical information, so that the corresponding decoders can identify which Wiener filter was employed for each block partition during the encoding process. The Wiener filtering information may also comprise the filter coefficients and/or the block partition information.

The decoder 300 comprises an entropy coding unit 380, an intra prediction unit 305, an inter (Motion Compensation; MC) prediction unit 310, an inverse transform unit 327, an inverse quantization unit 329, a reconstruction unit 330, a deblocking unit 340, a Wiener filtering unit 360, and a frame buffer 350. The entropy coding unit 380 receives a coded bitstream to decode and extract prediction information such as intra mode information and inter mode information, Wiener filtering information, and residues. The Wiener filtering information is sent to the Wiener filtering unit 360 for selecting a Wiener filter from a plurality of Wiener filters for each block partition of a parent block. The Wiener filtering unit 360 will select the same Wiener filter used at the encoder side according to the Wiener filtering information. The Wiener filtering information may comprise filter coefficients for the Wiener filters corresponding to the parent block, and the Wiener filtering information may also comprise block partition information for filtering processes.

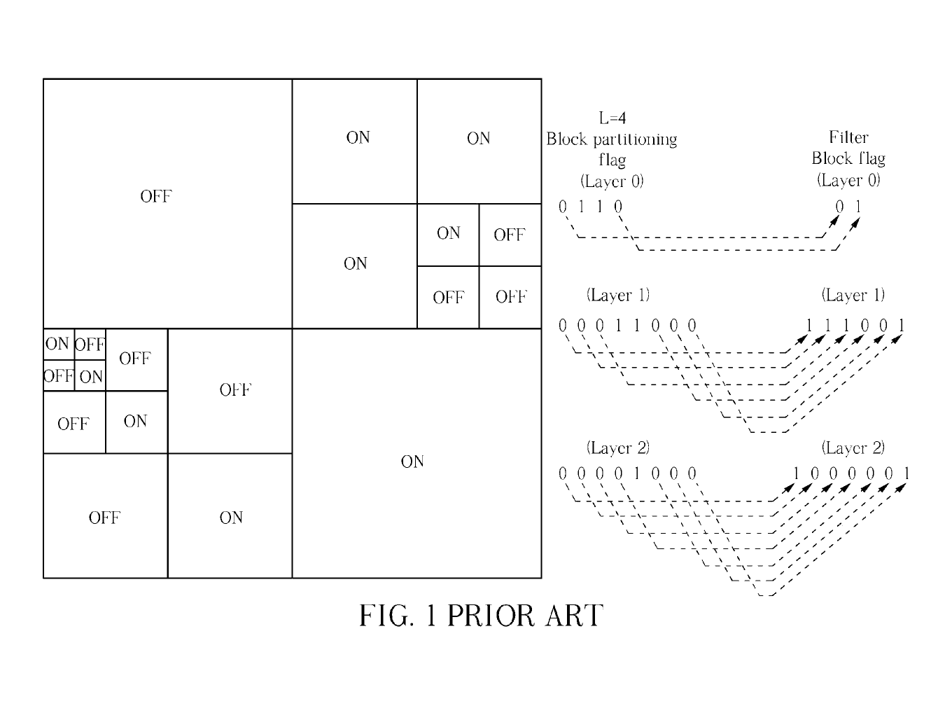

Please refer to FIG. 1. FIG. 1 is a diagram of a frame that is divided according to quadtree block partitioning. As is well-known to those skilled in the art, quadtree partitioning is a way of dividing and sub-dividing a parent block until an area requiring common coding information (e.g. motion vector and reference picture index) is reached. For example, in a frame where there is a moving image in the lower half but the upper half remains static, only motion prediction needs to be applied to the lower half of the frame, whereas the upper half can duplicate coded date used for the previous frame. As shown in the diagram, the frame is initially divided into four, and then some quarters of the frame are further divided into four until each block partition has common coding information, in this embodiment, the coding information is whether a filtering process is applied to the block partition. The example shown in FIG. 1 demonstrates that each block partition in a frame can be processed by filtering (i.e. ON) or it can bypass the filtering process (i.e. OFF). For the upper left quarter, it has been determined that no filtering is required; for the bottom right quarter, it has been determined that filtering is required. For the other quarters, filtering is only required for some block partitions of the quarter. Therefore, each quarter is split into four again, and the above determinations are made for the sub-divided sections. This partitioning occurs again and again until a desired level of coding accuracy is achieved. Please note that FIG. 1 represents a frame, but this quadtree partitioning can be performed at other levels. Furthermore, the quadtree partitioning in FIG. 1 is utilized to determine whether to filter or not.

It is possible, however, that even within one picture there exist at least two areas that both require Wiener filtering but have different statistical properties and therefore require different Wiener filters. If more than one Wiener filter can be utilized on a parent block (such as a picture), then even smaller errors between original signals and filtered signals can be achieved. The parent block is divided according to quadtree partitioning, or any other partitioning methods.

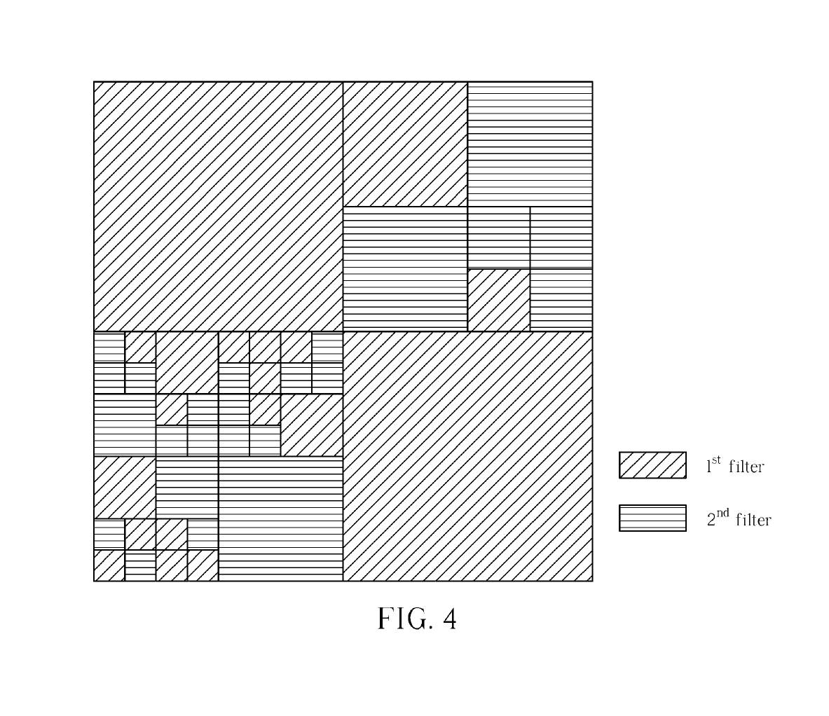

Please refer to FIG. 4, which is a diagram of a parent block that is filtered according to a first exemplary embodiment of the present invention. As can be seen from FIG. 4, the parent block is filtered according to two Wiener filters, wherein the parent block is sub-divided according to quadtree partitioning. At each block partition it will be determined which Wiener filter is a best fit. The block partitions of the parent block are the leaf blocks, and data within a block partition are filtered by the same Wiener filter. Please note that the diagram only shows two Wiener filters for simplicity, but more than two Wiener filters may be utilized in some other embodiments, and the spirit of the invention will be the same. As the number of Wiener filters increases, the time and complexity for the filtering operation will also increase; therefore the number of Wiener filters can be decided according to designers' requirements.

At the encoder side, the filter coefficients for both the 1^{st} and the 2^{nd} Wiener filters will be generated, and this information as well as the block partition information may be sent to the decoder side. It is also possible that the decoder side derives the filter coefficients and block partition information according to video data and/or information carried in the bitstream. The encoder side generates a filter index for each block partition, which is utilized alongside the block partition information to inform the decoder which Wiener filter has been used for each partition. It is possible to embed this information in the slice header so it is received first by the decoder 300, or to embed it elsewhere in the bitstream and have a pointer that indicates the location of this Wiener information so that the decoder 300 can access the information at the start of the decoding process.

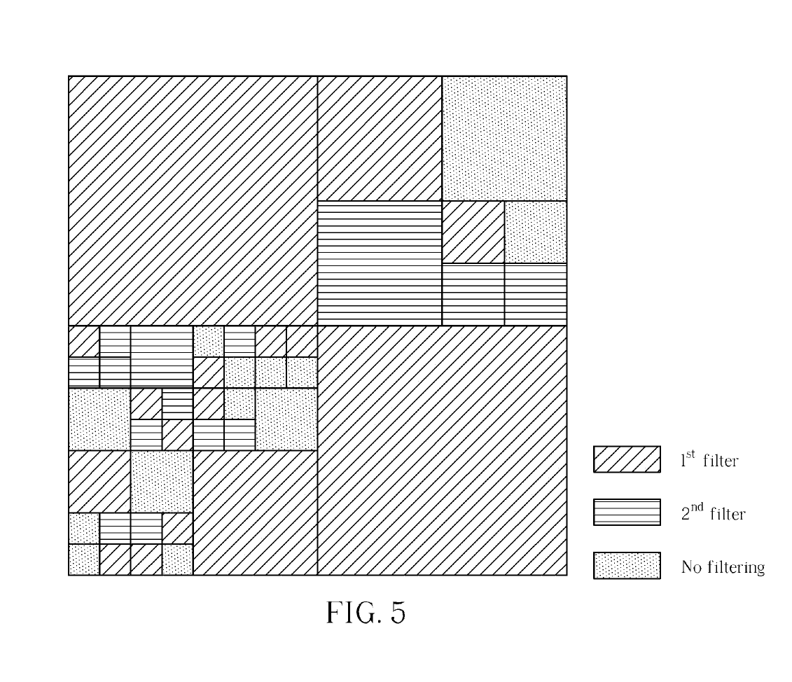

Please refer to FIG. 5, which is a diagram of a parent block that is filtered by a filtering method according to a second exemplary embodiment of the present invention. As in FIG. 4, a parent block is divided into a plurality of block partitions using quadtree partitioning, and two Wiener filters are utilized to filter the block partitions. It is also possible in this embodiment that, for certain areas of the parent block, no filtering process is required. Again, it will be appreciated by those skilled in the art that more than two Wiener filters may be utilized, and the spirit of the invention will remain the same.

In this embodiment, the decoder is informed of the Wiener filter coefficients and block partition information and also whether or not Wiener filtering takes place. Therefore, in this embodiment, the filter index also carries the information of whether the block partition is filtered, for example, the filter index incorporates a flag which indicates that no filtering occurs. As in the first embodiment, this information can be transmitted in the slice header, or in another part of the bitstream wherein a pointer will be utilized to indicate the location of the information.

A filter calculation and selection example for the first and second embodiments is described below. Video data (e.g. pixel values) of a picture are divided into a dark part and a bright part, and the encoder trains two filters for the dark part and the bright part respectively. Block partitions belonging to the dark part are filtered by one filter and block partitions belonging to the bright part are filtered by another filter. Another filter calculation and selection example is to try both a first filter which is a standard filter and a second filter which is an optimal filter trained from a previous picture, and select the filter with a smallest error between the original signal and the filtered signal.

A third exemplary embodiment of the present invention determines which Wiener filter to use (or whether to use no filtering) according to statistics. As long as the way of determining the filter (e.g. filter coefficients) is the same at both the encoder and decoder side, it is not necessary to send the filter index to the decoder. This reduces the amount of information that needs to be sent in the bitstream.

At the decoder side, the filtering method for each block partition can be derived from the bitstream. In a first modification of this embodiment, the decoder will perform the same operation as the encoder in order to determine which filtering method is optimal for each block partition of a parent block. In a second modification, it is possible for the encoder to send some information (which will be significantly smaller than the filter index information of the first and second embodiments) to the decoder, which will then perform statistical computations on this information in order to determine the filtering methods employed.

A typical example is given here. A number of block partitions, i, within a current picture is between 1 and K, and a statistical value of each block partition, f(i), is calculated. These statistical values are then sorted in ascending or descending order and fitted into a number of bins, N. For each separate bin, a separate set of filter coefficients is utilized (i.e. a different Wiener filter is utilized for each bin). Data of block partitions within a bin will be trained and filtered by the same filter (i.e. employ the same filter coefficients). The bin sorting method can be predefined and known by both encoders and decoders, or the bin information can be sent to the decoder, which can therefore sort each block partition and filter accordingly. For example, the bin information includes N−1 threshold values, so that the decoder can sort the statistical values properly by comparing the statistical values with the threshold values.

Possible statistical values that can be utilized in the above example include: mean value of the reconstructed signal/residual signal/prediction signal, variance value of the reconstructed signal/residual signal/prediction signal, dynamic range of the reconstructed signal/residual signal/prediction signal (which means the absolute value of the difference between the maximum value and the minimum value within each block partition), etc.

In a fourth exemplary embodiment, block partition information for filtering process can be derived by decoders, and therefore, the encoder no longer needs to insert block partition information in the bitstream. A plurality of filters are designed for corresponding block partitions of a picture, and the corresponding block partitions can be either created simultaneously with the generation of the filters or inferred from the block-based structure in coding the picture. For example, the block partition for filtering processes can be the same as the coding unit partition, transform unit partition, or a predefined partition known by both encoders and decoders. Embodiments of the present invention are not limited to quadtree partitioning. In an example, the encoder transmits coefficients of a plurality of filters to the decoder as side information, and the encoder also transmits corresponding block partition information along with the filter coefficients. The corresponding block partition information may be a flag indicating the way of creating the block partitioning for filtering process. In another example, the encoder inferred from the block-based coding structure of the picture as block partition for filtering process, and the decoder utilizes the block-based coding structure for block partitioning of filtering process.

In the above detailed description, the level at which the block partitioning is performed will be called a parent block. It is to be understood that a parent block may mean an entire frame, or a frame may comprise many parent blocks.

To summarize, the above methods describe means for utilizing at least two filters to filter a parent block, wherein the parent block will be sub-divided into block partitions utilizing quadtree partition or other partition methods, and block partition information, and filter indexes are optionally sent to the decoder side. For example, the block partition information for filtering processes can be derived by the decoder in some embodiments, and a filter index for each block partition is not included in the bitstream as the type of filtering can be derived by the decoder in some other embodiments. These methods may offer greater coding accuracy by further reducing mean quantization errors between original signals and filtered signals than in systems where only one filter is used per parent block. These methods may also offer greater coding efficiency by having the decoders derive certain filtering information to reduce the bitstream data size.

Those skilled in the art will readily observe that numerous modifications and alterations of the device and method may be made while retaining the teachings of the invention.

1. A method for coding a parent block of video data, the method comprising:
reconstructing the parent block for prediction;
providing at least two filters for filtering the parent block after reconstructing the parent block;
dividing the parent block into block partitions, wherein at each block partition determining which of the filters is to be used to filter the block partition; and
filtering each of the block partitions with the filter determined accordingly.

2. The method of claim 1, further comprising:
encoding residues and prediction information of the parent block into a coded bitstream;
generating block partition information corresponding to the divided parent block;
generating a filter index indicating the filter to be used for each block partition;
generating filter coefficients for each filter to be used; and
embedding the filter coefficients, the block partition information, and the filter index in the coded bitstream.

3. The method of claim 2, wherein the block partition information, the filter index and the filter coefficients are embedded in the tail of the coded bitstream, and the method further comprises:
using a pointer in the header of the coded bitstream to indicate the location of the block partition information, the filter index and the filter coefficients.

4. The method of claim 2, wherein at each block partition determining which of the filters is to be used to filter the block partition, further comprises determining whether or not to filter the block partition, if the block partition is determined not to be filtered, the filter index corresponding to the block partition indicates no filtering process for the block partition.

5. The method of claim 1, further comprising:
decoding a coded bitstream to retrieve residues, prediction information, and filtering information; and
determining the filter to be used for each block partition according to the filtering information.

6. The method of claim 1, further comprising:
decoding a coded bitstream to retrieve residues, prediction information, and filtering information; and
dividing the parent block into the block partitions according to the filtering information.

7. The method of claim 1, wherein at each block partition determining which of the filters is to be used to filter the block partition, further comprises determining whether or not to filter the block partition.

8. The method of claim 1, wherein at each block partition determining which of the filters is to be used to filter the block partition, further comprising:
calculating a statistical value of each block partition of the parent block;
sorting the statistical values and fitting into different bins, wherein each bin corresponds to one of the filters; and
filtering the block partitions within each bin utilizing the corresponding filter.

9. The method of claim 8, further comprising:
encoding residues and prediction information of the parent block into a coded bitstream;
generating block partition information corresponding to the divided parent block;
generating filter coefficients for each filter to be used; and
embedding the filter coefficients and the block partition information in the coded bitstream.

10. The method of claim 8, further comprising:
encoding residues and prediction information of the parent block into a coded bitstream; and
embedding a threshold in the coded bitstream, wherein the threshold is used for comparing with each of the statistical values to decide which one of the bins to be fitted into.

11. The method of claim 8, further comprising:
decoding a coded bitstream to retrieve residues, prediction information, and filtering information, wherein the filtering information comprises a threshold for comparing with each of the statistical values to decide which one of the bins to be fitted into.

12. The method of claim 8, wherein the statistical values are selected from a group comprising: mean value; variance value; and dynamic range.

13. The method of claim 8, further comprising:
training a set of filter coefficients for each filter and filtering the block partitions utilizing the corresponding set of trained filter coefficients.

14. The method of claim 1, further comprising:
decoding a coded bitstream to retrieve residues and prediction information; and
dividing the parent block into the block partitions by inferring from the parent block.

15. The method of claim 14, wherein dividing the parent block into the block partitions by inferring from a block-based structure of the parent block, and the block-based structure is one of a coding unit partition, a transform unit partition, and a predefined partition.

16. A method for coding a parent block of video data, the method comprising:
reconstructing the parent block for prediction;
dividing the parent block into block partitions according to a partitioning method;
determining one of a plurality of filtering methods for each of the block partitions; and
filtering each of the block partitions with the corresponding filtering method;
wherein the partitioning method is inferred from the parent block.

17. The method of claim 16, wherein the partitioning method is inferred from a block-based structure of the parent block, and the block-based structure is one of a coding unit partition, a transform unit partition, and a predefined partition.

18. The method of claim 16, further comprising:
encoding residues and prediction information of the parent block into a coded bitstream; and
embedding a flag in the coded bitstream, wherein the flag indicates the way of creating partitioning information to be used for dividing the parent block.

19. The method of claim 16, further comprising:
decoding a coded bitstream to retrieve residues and filtering information; and
determining the way of creating partitioning information to be used for dividing the parent block according to the filtering information.

20. The method of claim 16, wherein determining one of the filtering methods for each block partition comprises determining whether or not to perform a filtering process to reduce errors between reconstructed block partitions and original block partitions.

21. The method of claim 16, wherein determining one of the filtering methods for each block partition comprises determining a set of filtering coefficients from a plurality of sets of filtering coefficients for each block partition.

22. The method of claim 16, wherein determining one of the filtering methods for each block partition, further comprising:
calculating a statistical value of each block partition of the parent block;
sorting the statistical values and fitting into different bins, wherein each bin corresponds to one of a plurality of filters; and
filtering the block partitions within each bin utilizing the corresponding filter.

23. The method of claim 22, further comprising:
encoding residues and prediction information of the parent block into a coded bitstream;
generating filter coefficients for each filter to be used; and
embedding the filter coefficients in the coded bitstream.

24. The method of claim 22, further comprising:
encoding residues and prediction information of the parent block into a coded bitstream; and
embedding a threshold in the coded bitstream, wherein the threshold is used for comparing with each of the statistical values to decide which one of the bins to be fitted into.

25. The method of claim 22, further comprising:
decoding a coded bitstream to retrieve residues, prediction information, and filtering information, wherein the filtering information comprises a threshold for comparing with each of the statistical values to decide which one of the bins to be fitted into.

26. The method of claim 22, wherein the statistical values are selected from a group comprising: mean value; variance value; and dynamic range.

27. The method of claim 8, further comprising:
training a set of filter coefficients for each filter and filtering the block partitions utilizing the corresponding set of trained filter coefficients.

28. An encoder for encoding a parent block of video data, comprising:
a reconstruction block, for reconstructing the parent block for prediction;
at least two filters for filtering the parent block after reconstructing the parent block; and
a filtering information generation unit, for dividing the parent block into block partitions, wherein at each block partition the filtering information generation unit determines which of the filters is to be used to filter the block partition.

29. The encoder of claim 28, wherein the filtering information generation unit generates block partition information corresponding to the divided parent block, a filter index indicating the filter to be used for each block partition, and filter coefficients for each filter to be used; and
the encoder further comprises:
an encoding block, for encoding residues and prediction information of the parent block into a coded bitstream, and embedding the filter coefficients, the block partition information, and the filter index in the coded bitstream.

30. The encoder of claim 28, wherein at each block partition, the filtering information generation unit determines whether or not to filter the block partition, and if the block partition is determined not to be filtered, the filter index corresponding to the block partition indicates no filtering process for the block partition.

31. A decoder, for decoding a parent block of video data, comprising:
a decoding entropy unit, for decoding a coded bitstream to retrieve the parent block of video data;
a reconstruction block, for reconstructing the parent block for prediction;
at least two filters for filtering the parent block after reconstructing the parent block;
a filtering information generation unit, for dividing the parent block into block partitions, wherein at each block partition the filtering information generation unit determines which of the filters is to be used to filter the block partition.

32. The decoder of claim 31, wherein the decoding entropy unit decodes the coded bitstream to retrieve residues, prediction information, and filtering information, and the filtering information generation unit determines the filter to be used for each block partition according to the filtering information.

33. The decoder of claim 32, wherein at each block partition, the filtering information generation unit determines whether or not to filter the block partition, and if the block partition is determined not to be filtered, the filter information corresponding to the block partition indicates no filtering process for the block partition.

34. The decoder of claim 31, wherein the filtering information generation unit divides the parent block into the block partitions by inferring from a block-based structure of the parent block, and the block-based structure is one of a coding unit partition, a transform unit partition, and a predefined partition.
